(19) United States
(12) Patent Application Publication
(10) Pub. No.: US 2007/0136573 A1
(43) Pub. Date: Jun. 14, 2007

(54) System and method of using two or more multi-factor authentication mechanisms to authenticate online parties

(76) Inventor: Joseph Steinberg, Teaneck, NJ (US)

Correspondence Address: KLAUBER & JACKSON, 411 HACKENSACK AVENUE, HACKENSACK, NJ, 07601, US

(21) Appl. No.: 11/606,788

(22) Filed: Nov. 30, 2006

Related U.S. Application Data
(60) Provisional application No. 60/742,498, filed on Dec. 5, 2005.

(51) Int. Cl. H04L 9/00

(52) U.S. Cl. 713/155

(57) ABSTRACT

A system and method for authentication that comprises the use of at least one multiple multi-factor authentication with the optional addition of, mutual (site) authentication, transaction/behavior analysis, that utilizes user-facing geolocation communications and/or information about user device ownership periods, and/or a combination thereof to help prevent fraud.

### RELATED APPLICATIONS

The present application claims priority under 35 U.S.C. §120 from U.S. non-provisional patent filing Ser. No. 11/258,593 filed Oct. 25, 2005, which claims priority from U.S. non-provisional patent filing Ser. No. 11/114,945 filed Apr. 26, 2005, which claims priority from U.S. provisional patent application Ser. No. 60/565,744 filed on Apr. 27, 2004, and from U.S. provisional patent application Ser. No. 60/742,498 filed on Dec. 5, 2005, the entire disclosures of which are hereby incorporated by reference.

### BACKGROUND OF THE INVENTION

While secret passwords have been used for millennia to prove one's identity or that a party is authorized to access a specific resource, the use of passwords as a method of authentication poses risks—if an unauthorized party discovers, intercepts, or otherwise obtains a password he/she/it can gain inappropriate access to sensitive resources. In today's electronic age —in which sensitive information can be accessed and transactions can be executed online (including via telephone communications with humans and/or computers) after unseen parties authenticate—stronger forms of authentication are often appropriate. Furthermore, various approaches of addressing the problem of weak authentication have proven ineffective across the Internet. For example, requiring users to provide two distinct passwords instead of one, or asking users to provide a password and answer a question, as some systems have used, are actually less secure than a single longer password. It is often harder to crack one long password then to discover two short ones as there is no indication of success after cracking half of the former, but there is usually an indication once one password has successfully been successfully calculated. Furthermore, in the case of challenge questions, if users are allowed to pick questions and set their answers they may pick questions that are not truly secret—e.g., what is my birthday?—which may be accessed by criminals from public records or on the Internet. If users are required to pick from specific questions and provide answers they may (and, in fact, are likely) to reuse answers to secret questions on multiple sites undermining the security value of answering the questions and setting the access security for all of the sites on which the question/answer was used to that of the lowest level among all of the sites on which it was used. A phishing site can easily ask for a user's password and mother's maiden name—as such, it is clear that requesting these two pieces of information (or any similar piece of information in conjunction with a password) is not a good way to combat phishing and online fraud—and that it is unwise to condition users to submit sensitive information to online systems prior to knowing the identity of the online systems. Furthermore, once compromised the answers to many challenge questions (e.g., what is your mother's maiden name, what is your social security number, in what city were you born, etc.) cannot be reset—and so the compromise of such information even once can lead to a lifetime of increased risk of identity theft. Furthermore, even if the compromise is discovered immediately after occurring—as would normally allow for reaction to prevent fraud—in the case of challenge questions once the secrets are compromised they can never be restored to secrecy.

Some have suggested that to improve authentication, users should prove their identities using not only a secret (password or answer), but also with something to which they possess access (either physical or digital access) or with something such as biometrics. Yet, as those skilled in the art will appreciate, just as passwords and challenge questions may prove inappropriate for strong authentication across the Internet, so may digital certificates, biometrics, USB devices, hardware tokens and one-time password generating cards, and other forms of authentication.

### SUMMARY OF THE INVENTION

To this end, the present invention provides a system and method for providing strong authentication without any of the aforementioned drawbacks, and in addition, with minimum inconvenience to users. Contemplated within the scope of this invention are several novel elements which may be implemented independently or together.

One aspect the present invention offers a unique system and method for the use of two or more forms of multi-factor authentication (that is two, different systems, each of which requires a password in addition to a second authentication mechanism that does not rely on users entering a regular password/answer to a question) with a more convenient one used whenever possible, and another method used when necessary. The goal of such a system is to always provide strong or two factor authentication, all the while providing maximal convenience for users. In addition to the email based one time passwords described below, a cellphone could be used to authenticate by sending it a barcode to display so it can be scanned by a reader, using RFID within the cellphone, having the cellphone use its wireless capabilities and ESN to create an RID-like identification, and other ways. Thus, the invention may also include the use of such systems for other purposes including sending bar codes to phones/mobile devices for use as coupons to be scanned at a grocer. For the sake of this patent, barcode is used to mean not only two-dimensional bar-based scannable images such as UPC symbols, but any generated image that is scannable and readable by another electronic device.

In another aspect, the present invention offers a novel system and method that employs site or email authentication in conjunction with true multi-factor authentication.

In another aspect, the present invention offers a novel system and method to use site authentication in such a way that a system being accessed authenticates the party accessing the system prior to that party having to type anything (i.e., prior to entering a username or other login credentials).

In yet another aspect, the present invention offers a novel system and method to use differentiated login pages, one for a user and machine that are trusted and one for a user and machine that is not trusted and one for a case in which only one of them (the user or the machine is trusted).

In yet another aspect, the present invention offers a novel system and method that provides the ability to have strong multi-factor authentication that is invisible to users.

In yet another aspect, the present invention offers a unique system and method that provides the novel triple protection combination of multi-factor authentication, site authentication, and transaction/behavior analysis.

In yet another aspect, the present invention offers a unique system and method that provides the ability to offer true multi-factor authentication without any user enrollment (other than that which has already occurred in order to offer single factor authentication).

In yet another aspect, the present invention offers a novel system and method that provides, among other things, the use of visible or audible site authentication when used with a remote access system such as a SSL VPN.

In yet another aspect, the present invention offers a novel system and method that provides the use of a login screen on which there is a button that the user must click in order to obtain information that must be entered on the login screen.

In yet another aspect, the present invention offers a novel system and method that provide the ability to address man-in-the-middle attacks through either or both of the following defenses: a) presentation of a recognizable (audible, visual, or otherwise recognizable) cue providing authenticity of a computer only when the user is accessing it from an identified machine (and a man-in-the middle would either not be identified or identified differently) b) sending a warning message via email, SMS, or some other carrier out of band to the user, such message potentially comprising part of a one-time-password message or separate.

In yet another aspect, the present invention offers a novel system and method that provides communication out of band to a user, said communication comprising information detailing the geolocation information (in the form of text or a map) that shows where the user is accessing a given application or site from so that the user can detect any fraudulent access.

In yet another aspect, the present invention offers a unique system and method that provides for the use of a colored or uncolored word/s or other sets of characters within a colored box for site/mutual authentication.

In yet another aspect the present invention offers a unique system and method that delivers two systems (rather than one system) for identifying devices used for access, one being heuristic based, and one being based on the assigning of a value to that machine which is stored on the device or read from the device.

In yet another aspect, the present invention offers a novel system and method that provides for the use of user information in order to determine whether multiple users should be allowed to assign a particular device as trusted.

In yet another aspect, the present invention offers a novel system and method that allows setting business security policies based on information about how trusted a device is for a particular user or users in general (based on binding it to specific users).

In yet another aspect, the present invention offers a novel system and method that offers either site authentication, user authentication, or both, and leverages human psychology and the science of learning in its design.

In yet another aspect, the present invention offers a novel system and method to address the problem of broken image symbols tricking users into thinking that a missing visual cue is due to technical problems rather than a security concern. Furthermore, the invention includes stating to the user a message to the effect of “If you do not see your cue then there may be a security risk —please do not log in.” as opposed to the “If you see your cue it is safe to login” as is used by other systems today.

In yet another aspect, the present invention offers a novel system and method to utilize any combination of the above aspects in a federated scheme (e.g., multiple parties use the same cueing system, method, design, and/or code for site authentication).

In yet another aspect, the present invention offers a novel system and method to address site-to-user authentication for account opening using any of the aforementioned techniques as various methods, systems, and/or executable code implementations.

In yet another aspect, the present invention offers a novel system and method to address site-to-user authentication for first time use of online communications for a given user who has existing relationship with the entity to which he or she is communicating online (e.g., enrolling in online banking) using any of the aforementioned methods, systems, designs, and/or codes.

In yet another aspect, the present invention offers a novel system and method to display of a visual/audible cue in an email message combined with encryption. Cues could be based on certificates, hashing, algorithms, databases, Sender ID info, Domain Keys, SPF, S/MIME info, etc.

In yet another aspect, the present invention offers a novel system and method to display a visual cue in an email message based on a calculation, set of bits, or number)(e.g., human friendly representation of certificates , digital signatures, hashing, algorithms, databases, Sender ID info, Domain Keys, SPF, S/MIME info).

In yet another aspect, the present invention offers a novel system and method to display text explaining the contents and color of a visual cue underneath it or to display/convert to audio the content of an audio or other sensory-based cue (for use with computers and/or other mediums such as telephone, etc.)

In yet another aspect, the present invention offers an extension to unique front-end and back-end protection by preventing security incidents and fraud through the creation and application of business logic based on indicia such as: information garnered about user devices and the length of time a user device known to belong to a specific user; or when the login pattern of the user from that device has a significant deviation (such as not allowing a user to change passwords online unless he is logging in from a device that the system know belongs to the user for at least thirty days).

In yet another aspect, the present invention offers use of novel site authentication through the use of cues in the non-electronic world.

In yet another aspect, the present invention offers a novel expiration of “trusted” status based on actions rather than time.

In yet another aspect the invention includes the use of geo-location information available from cellphones and handheld/mobile devices to authenticate users.

In yet another aspect, the present invention offers a novel system and method to combine any or all of the above inventions.

### BRIEF DESCRIPTION OF THE DRAWINGS

FIG. 1 depicts an exemplary implementation of one embodiment of the present invention where a user attempts to access a site protected by the invention from a machine which he is not known to possess.

FIG. 2 depicts an exemplary situation where the user enters the one time password that he has received as well as his normal username and password and submits them to the web site.

FIG. 3 depicts an exemplary situation where the one-time password, username, and password combination is not correct the user cannot log in.

FIG. 4 depicts an exemplary situation where the one time password, username, and password combination all correspond and are correct the user is logged in.

FIG. 5 depicts an exemplary situation where the user has chosen to make the site trust him from the particular device he is using.

FIG. 6 depicts an exemplary situation where the user accesses the business system.

FIG. 7 depicts an example of the user login from a trusted machine in an implementation in which mutual authentication is enabled.

FIG. 8 depicts an exemplary situation where a person enrolling to become a new user of the business system where no enrollment in the strong authentication system is needed.

FIG. 9 depicts an exemplary drop-down box of the configurations that might be employed in sending maps to determine log in origination and heuristic analysis scoring.

FIG. 10 depicts an exemplary drop-down box of the rules that might be employed in establishing trusted device determinations.

FIGS. 11A-J depict exemplary flows of an illustrative implementation of the invention and illustrative log in specifics.

### DETAILED DESCRIPTION

At its broadest level, the present invention comprises a method, a system having various modules for executing the steps of said method, and novel executable code that may be used on computer based systems as known in the art of security and authentication, all of which may providing for the following described embodiments. In one embodiment, the present invention comprises provision of improved authentication of interacting parties comprising the use of two or more forms of authentication, each of which uses at least two methods of authenticating users, the form of authentication comprising: a multi-factor authentication step for authenticating a user from a computer, the multi-factor authentication comprising features chosen from the group of using one-time password verification, using certificates, using Public Key Infrastructure components, using hardware devices that can be attached to a system, or using biometrics or other techniques; assessing a trusted status of the computer, the user, and the system, based upon analyzing of a result of the step of multi-factor authentication. In a further embodiment, the present invention comprises a comprises provision of site authentication between a user and a system being accessed to authenticate themselves to each other and further including analysis of a result of the site authentication so as to further assess the trusted status of said computer, the user and the system. In a further embodiment, the present invention comprises provision of transaction/behavior analysis in performing the aforementioned authentication. In a further embodiment, the present invention comprises provision for a given system that is being accessed to authenticate the user accessing the given system prior to the user having to submit login credentials. In a further embodiment, the present invention provides for the hiding of at least some authentication factors from a user. In a further embodiment, the present invention comprises the ability to address man-in-the-middle attacks through the presentation of at least one recognizable cue in order to establish authenticity of a computer only when a user is accessing from an identified computer. In a further embodiment, the present invention comprises the provision of a warning message via email, SMS, or other out of band carrier to a user to warn of possible existence of said man-in-the-middle attacks. In a further embodiment, the present invention comprises the presentation of a recognizable audible, visual, or other cue indicating the trusted status of the computer of the user. In a further embodiment, the present invention comprises a the provision of communication out-of-band to a user indicating geolocation information in the form of text or a map that shows at least a general location where a user is accessing a system so that said user can detect any fraudulent access. In a further embodiment the present invention comprises the use of a barcode, ESN, telephonic native capabilities, or other properties of a mobile device and data to confirm location and/or identity. In a further embodiment, the present invention comprises the provision of mutual authentication further provide for the authentication of computers involved in online sites, email messages, instant messages, SMS messages, telephone calls, ATM machine, paper-based messages, and other communication systems. In a further embodiment, the present invention comprises the provision of colored boxes with colored or uncolored characters within the box to a user as a cue for site/mutual authentication. In a further embodiment, the present invention comprises provision of portraying explanatory textual information along with said cue to said user so as to ensure that said system can authenticate within systems that can only process text. In a further embodiment, the present invention comprises provision of creating and applying business logic (e.g., pre-set rules) based on information garnered about devices of said user and a length of time during which said computer of said user is known to belong to a specific user and a login pattern of the user from said device. In a further embodiment, the present invention comprises provision of using both identifiers and heuristic analysis to determine the identity of a computer, user, or entity. In a further embodiment, the present invention comprises provision of ongoing modification of the assessment of said trust of a device of the user based upon analysis of user actions from the device of the user or from other computers utilized by the user. In a further embodiment, the present invention comprises provision of presenting a different login page for the user and said computer depending on whether each has been assessed as trusted or not trusted. In a further embodiment, the present invention comprises provision of assessing a trusted status further comprises at least one of the following steps: allowing a trusted status for multiple identified users accessing from the same identified computer, disallowing a trusted status for multiple users accessing the same device trusted, or allowing a trusted status for multiple identified users accessing from multiple computers according to pre-set conditions. In a further embodiment, the present invention comprises provision of providing authentication to a mobile electronic device comprising the steps of: producing a scannable barcode as known in the art of scannable barcodes, in a form that can be displayed for scanning by another device, the scannable barcode being produced through calculations performed on processors within the mobile electronic device; sending a signal to another electronic device for identification and authentication purposes, the signal comprising said scannable barcode and being modified based on information sent to the mobile electronic through a cellular, network, or other data connection; culling or processing at least an ESN present in the mobile electronic device to authenticate a user: sending the ESN in a secure (e.g., encrypted or hashed) fashion to another electronic device as a key. In a further embodiment, the present invention comprises provision of leveraging geolocation information made available by cell phones and handheld devices to a system being accessed in order to authenticate users, comprising the following steps: checking the location of a given computer, phone, handheld or other device being used to access a system; allowing access only if the location of said given computer, phone, handheld or other device being used to access a system are within a range of pre-set rules within the system. In a further embodiment the present invention includes informing users with a message substantially similar in content to “If you do not see your cue then there may be a security risk—please do not log in.” as opposed to the “If you see your cue it is safe to login” as is used by other systems today.

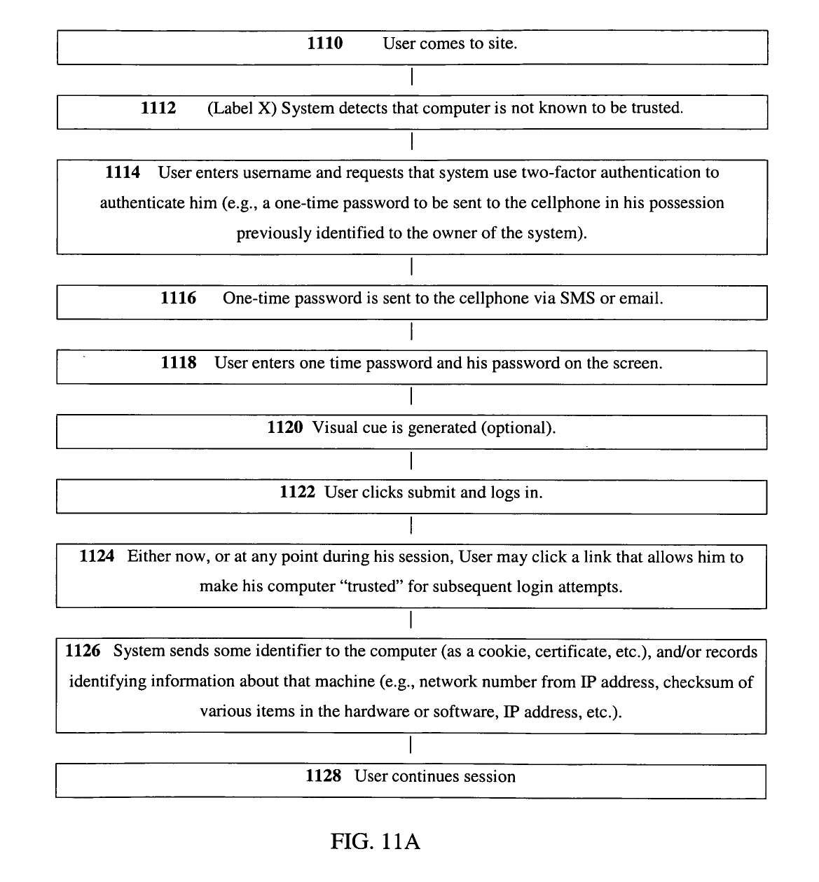

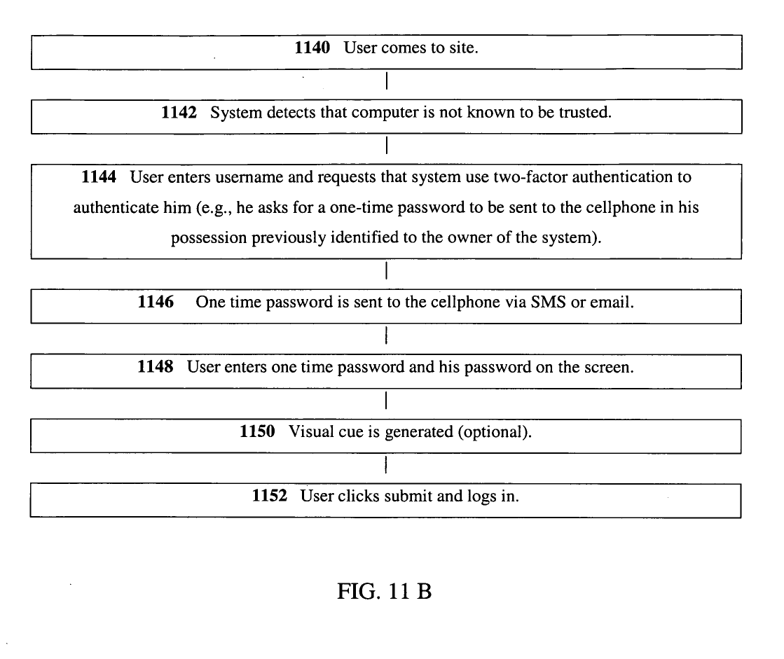

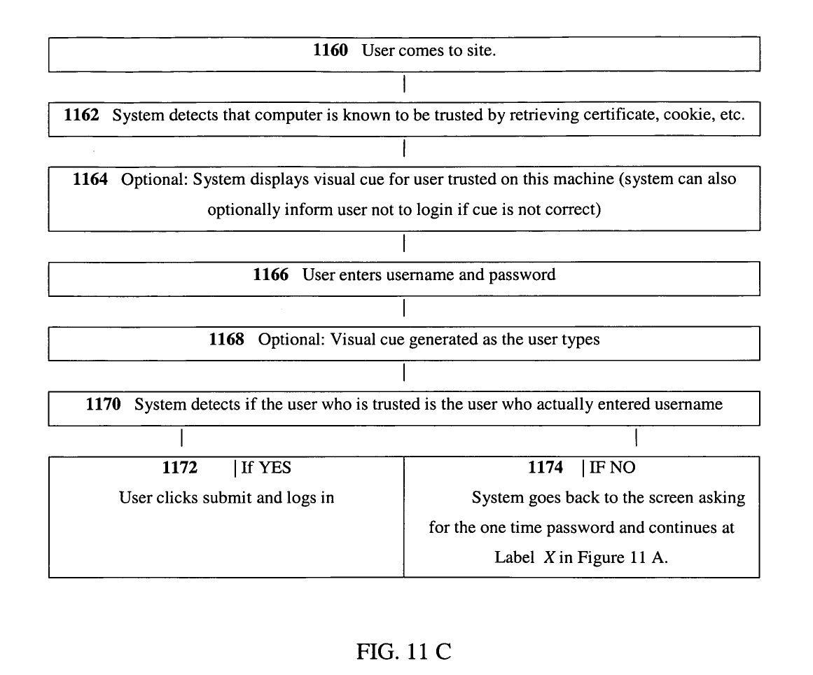

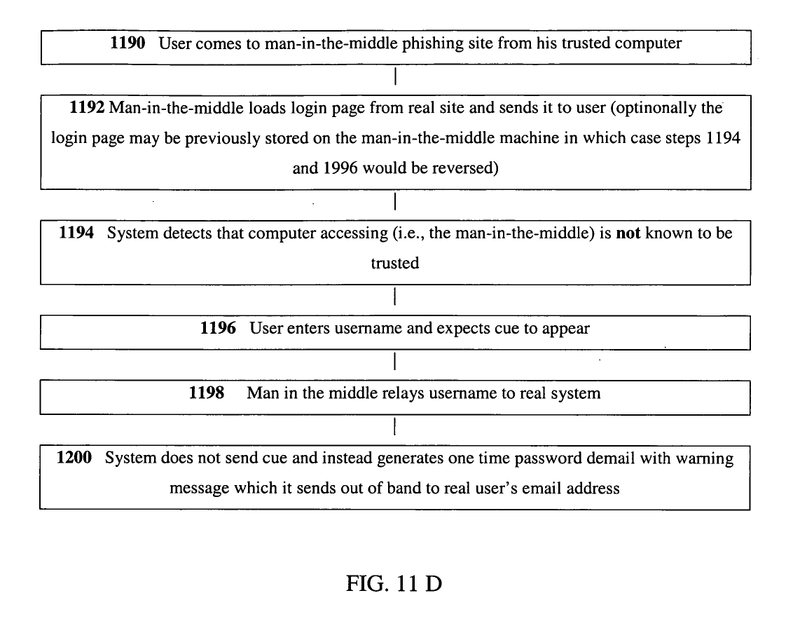

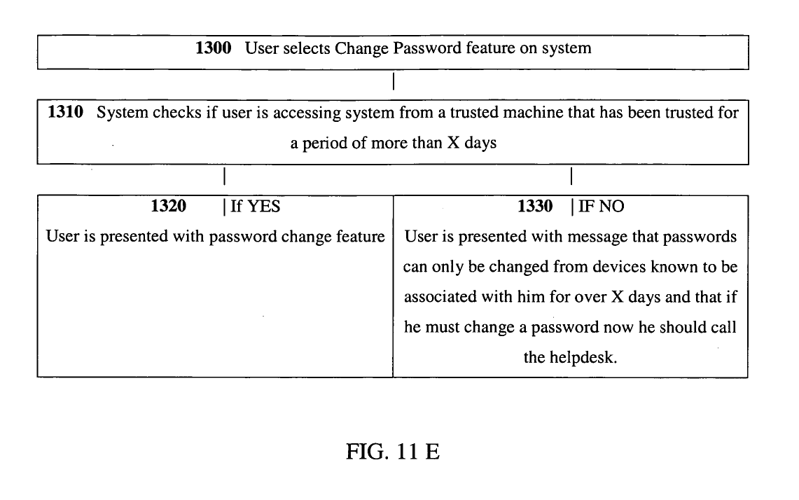

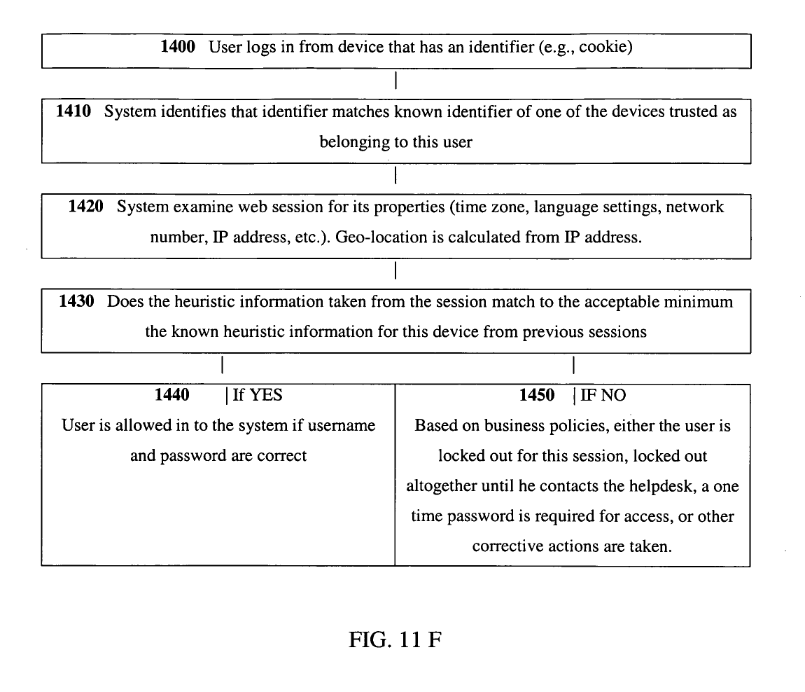

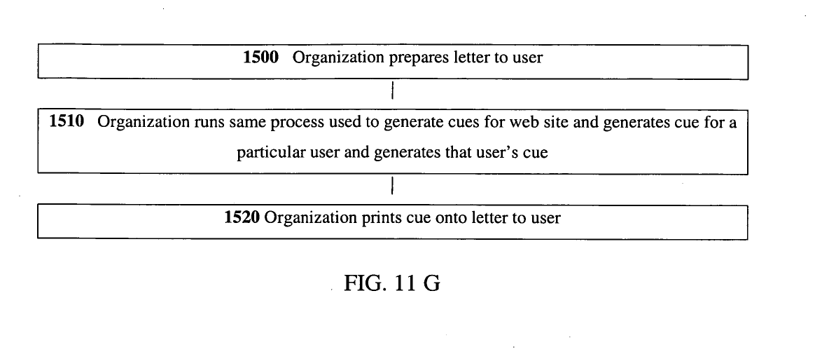

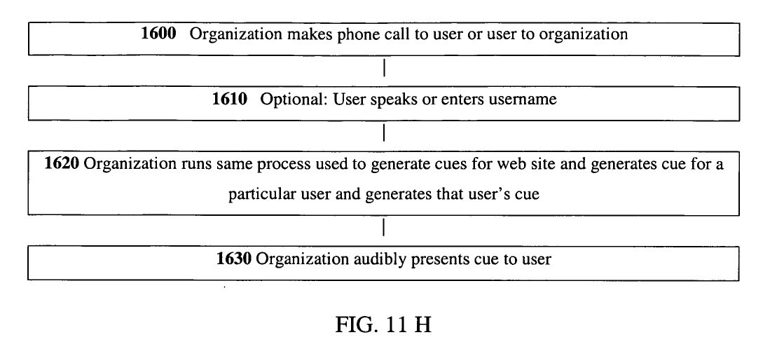

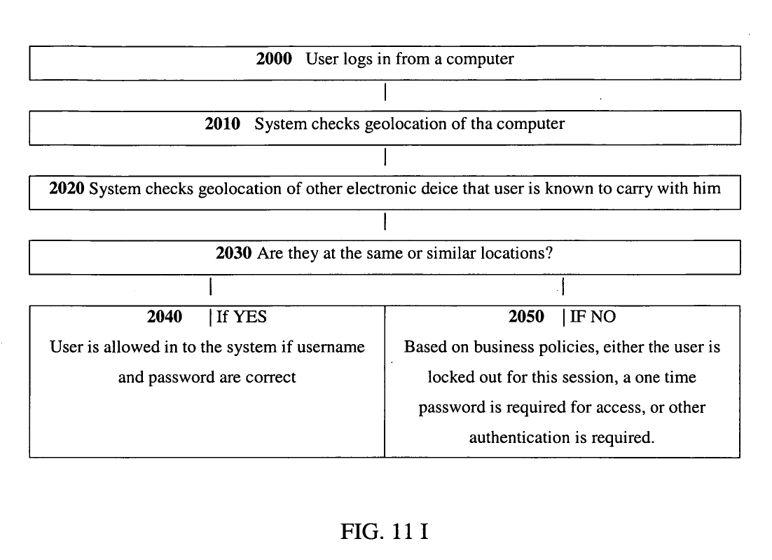

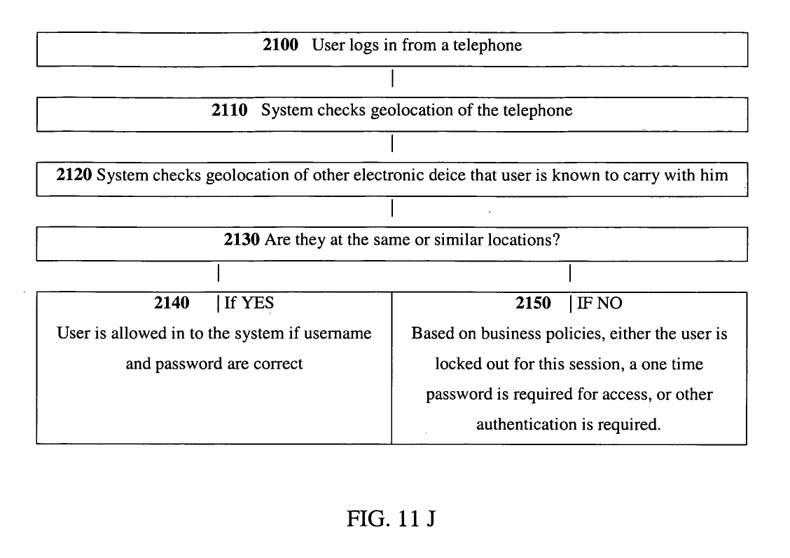

As will be readily apparent, the present techniques may be implemented across numerous systems (computers, internet, cell phones or other telephony, handheld devices, and virtually any other electronic devices) and will have various commercial and technical applications for authentication and identification. Accordingly, one exemplary implementation of the present invention may be shown in the case of computers and the internet through the following illustrative depiction involving a user who comes to a web site requiring authentication. When a user authenticates for the first time from a specific device, he is required to use a first method (alternately called method “A” herein) of the dual factor authentication. This method may entail the sending of a one-time password to a pre-agreed cellphone via SMS or via email to a user's email mailbox, followed by the user reading the one-time password and entering the one-time password into the online web system. The first method of dual authentication could also consist of the use of a standard token-generated one-time password such as that provided by RSA of Bedford, Mass. USA under the SecurID® product system, a biometric analysis such as an iris scan, or any other form of strong authentication. One part of this invention is a dual-factor system in which the user is authenticated by using a cell phone or other mobile device to which a barcode or other computer readable-code is sent (or a code is sent which the cell phone then displays in some computer readable format) which the user then displays to a scanning device. RFID—or the actual wireless capabilities of the cell phone or device—could also be used to transmit the information to a computer as part of this invention. Furthermore, another from of strong authentication that is an integral part of this invention is the use of the geolocation capabilities of cell phones and wireless devices as part of authentication. A user can be authenticated based on the fact that a device he is known to carry is in the location from which he is currently accessing the system (as described in FIG. 11-I). This novel approach simplifies authentication by not requiring the user to do anything. Derivations from this might be: checking what IP address his mobile device is on at the time that he logs in via another computer. As an example, in FIG. 11-I the reader can see that if a user logs in from a computer 2000, the system checks the geolocation information of that machine 2010 and of the device the user is known to carry (2020), and if they are the same (2030), then it lets him login (2040), and if not (2050) it either blocks access or requires stronger authentication. The same is true for phone access as shown in FIG. 11-J. Provision of such improves upon the usage of challenge questions—which are really just weak passwords—and are not a form of strong authentication. Following the user's authentication to the system, the system may provide the user the ability to make his system “trusted” or “identified” for future access attempts. If the machine is set as “trusted” (e.g., for this particular user, or in general) then the next time the user logs in, he will not need to perform method “A” of dual factor authentication, and instead a different dual factor check would then be performed. The system may identify the device as “trusted” either by sending a cookie, certificate, piece of data, or some identifier which is stored on the access device and checked upon subsequent access attempts and/or by performing a heuristic analysis of the communications with the device, and by identifying various properties to which future sessions can be compared (e.g., browser version, time zone of device, offset of clock from correct time in time zone, offset of clock from Greenwich Mean Time, IP address, network number, geolocation, etc.). As such, an emphasis of the present invention is the use of both types of methods in conjunction with one another. If, for example, a cookie is sent on the first login and detected on the second, the system can still use heuristics to ensure that the cookie was not hijacked and placed on another device from which access is being attempted. Likewise, if a cookie is missing, heuristics can determine whether it may have been wiped, but that the device is still, in fact, a trusted device for a particular user.

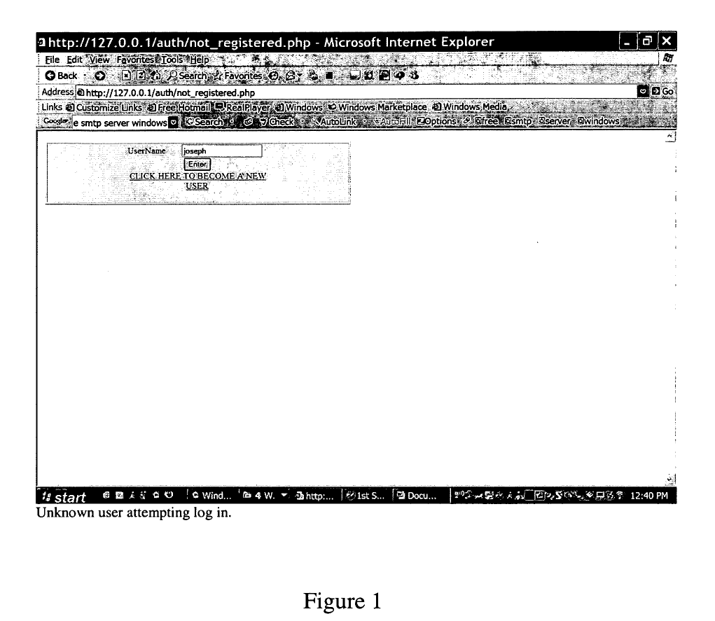

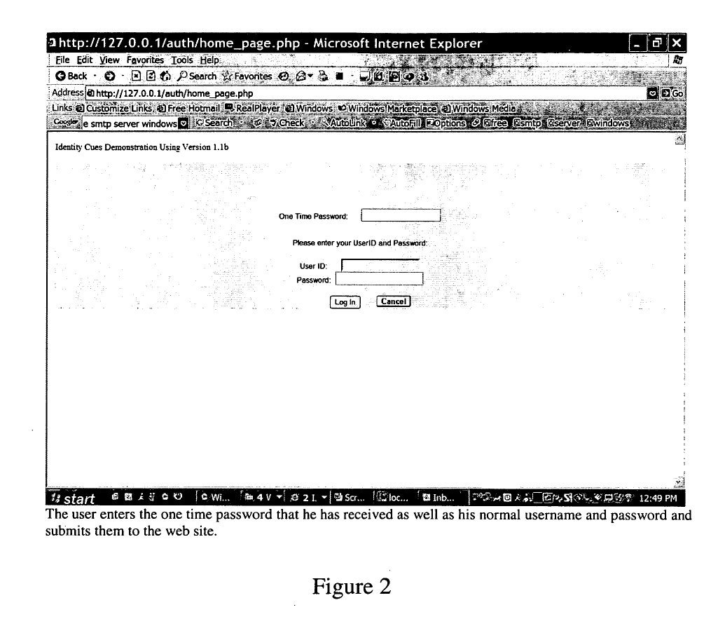

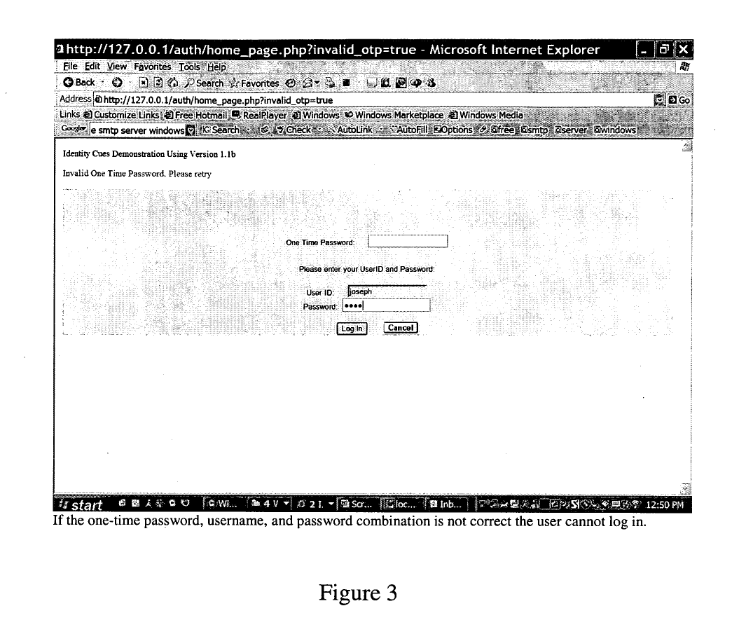

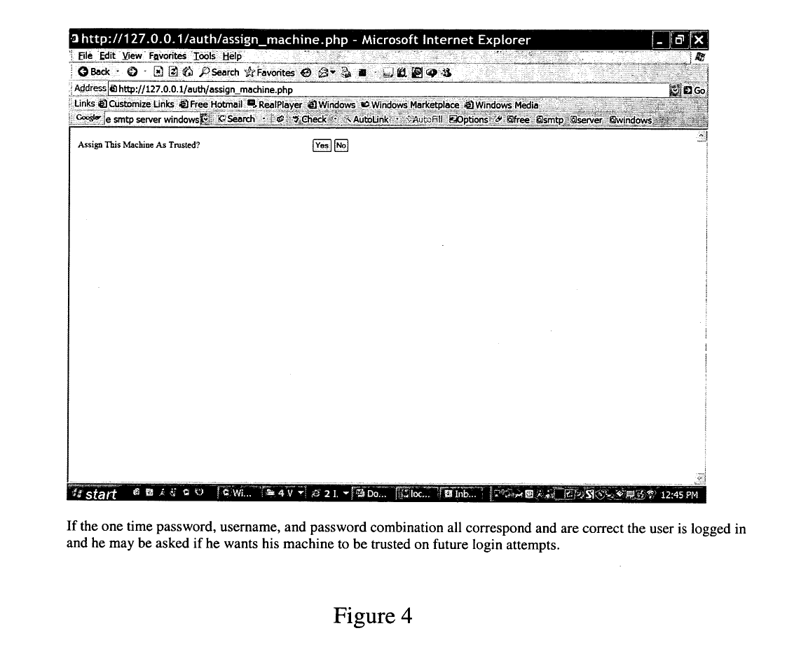

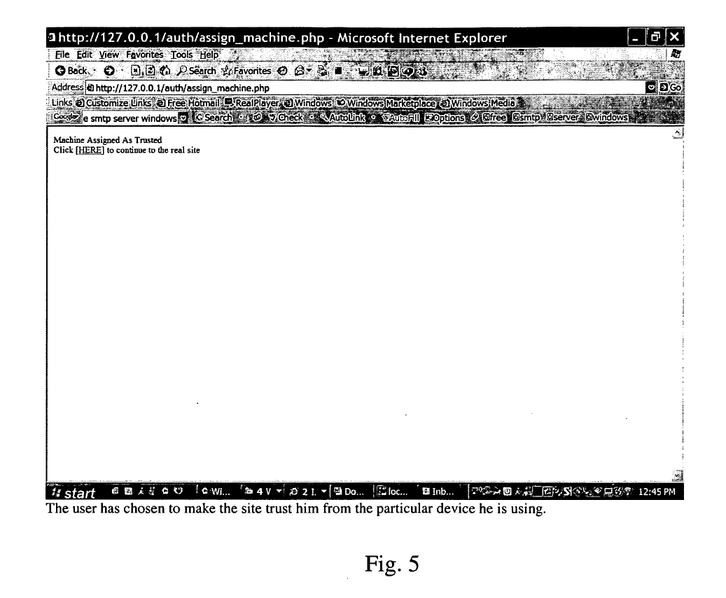

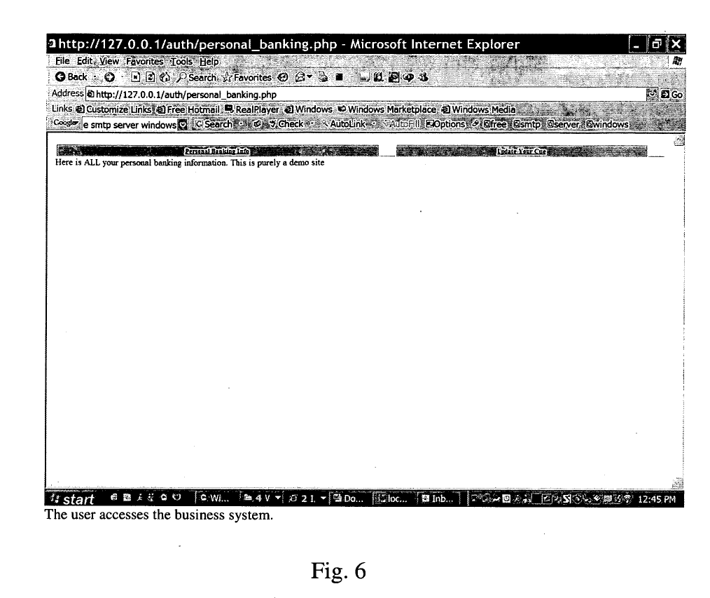

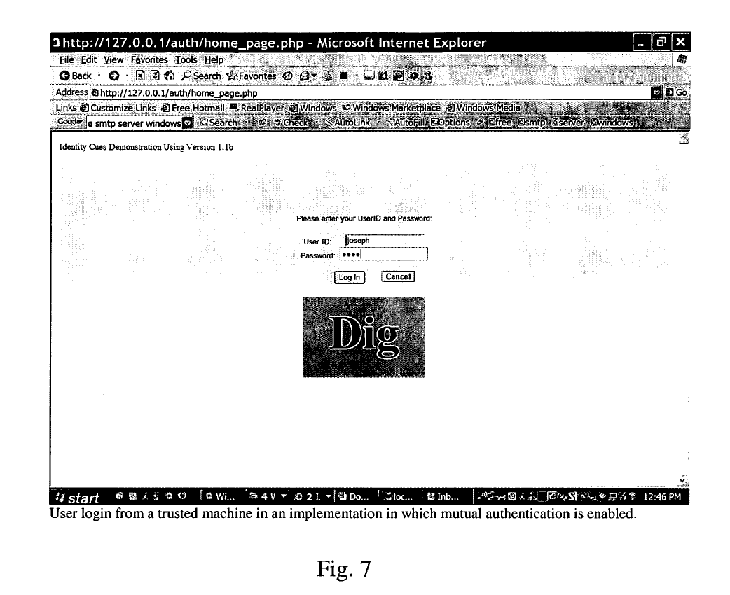

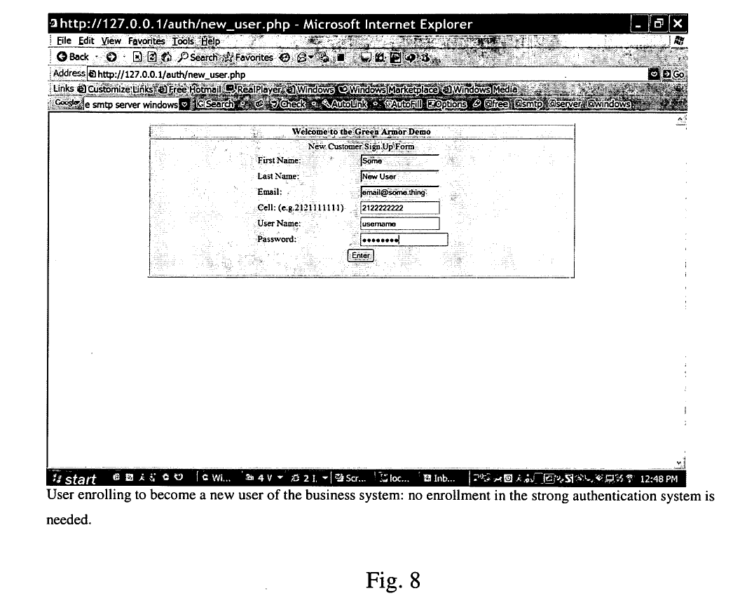

With broad focus on an overall illustrative implementation of the present invention, and with both specific and ongoing reference to FIGS. 1-7, attention is first drawn to FIG. 1, which depicts an exemplary implementation of one embodiment of the present invention where a user attempts to access a site protected by the invention from a machine with which he is not associated (known to possess or otherwise have access to). If he is a known user he enters his usemame to get a one time password sent to him out of band (e.g., SMS to cell phone), if he is a new user he clicks to register with the site. Conversely, FIG. 2 depicts an exemplary situation where the user enters the one time password that he has received as well as his normal username and password and submits them to the web site. Thereafter, FIG. 3 depicts an exemplary situation where the one-time password, username, and password combination is not correct the user cannot log in. FIG. 4 depicts an exemplary situation where the one time password, username, and password combination all correspond and are correct the user is logged in. In this example he is asked if he wants his machine to be trusted on future login attempts. FIG. 5 depicts an exemplary situation where the user has chosen to make the site trust him from the particular device he is using. The system identifies the user's device with two techniques: (1) it assigns an identifier to the machine by sending down a cookie; and (2) stores a profile of the user's device as determined by information from the web session. FIG. 6 depicts an exemplary situation where the user accesses the business system, while FIG. 7 depicts an example of the user login from a trusted machine in an implementation in which mutual authentication is enabled. The visual/audio/sensed cue could have been displayed before the user started typing anything (when the page initially loads) or as he typed. A message can be displayed to the user saying that if the cue is missing the user should not login as he may be at risk. The strong authentication second factor—which the device the user has is already in his possession at this point—is done in the background before the page loads. Hence there is no request for a one-time password. FIG. 8 depicts an exemplary situation where a person enrolling to become a new user of the business system wherein no enrollment in the strong authentication system is needed.

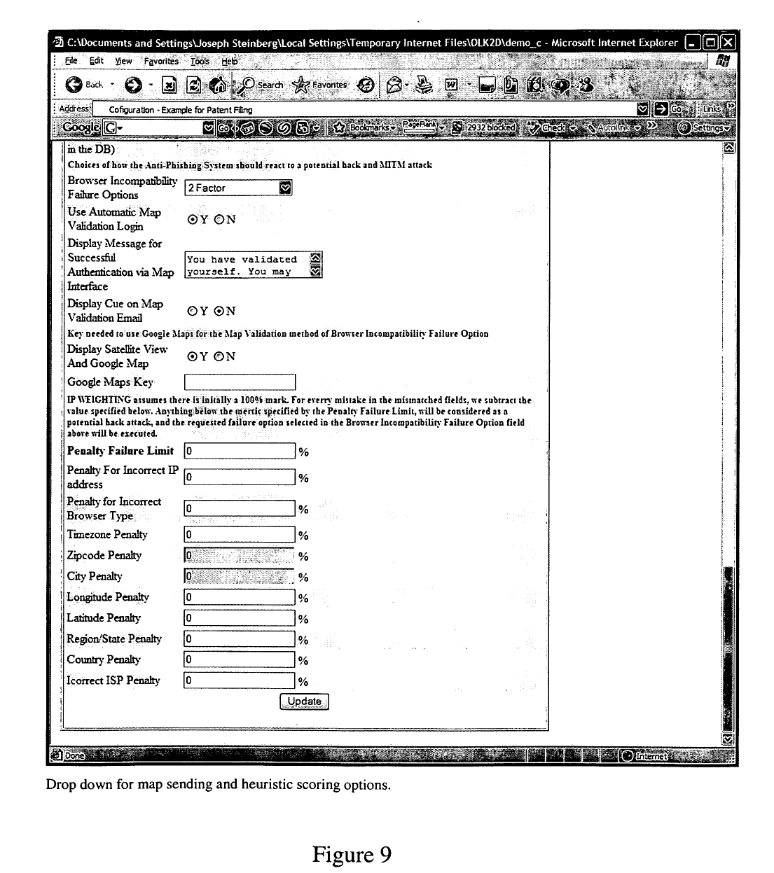

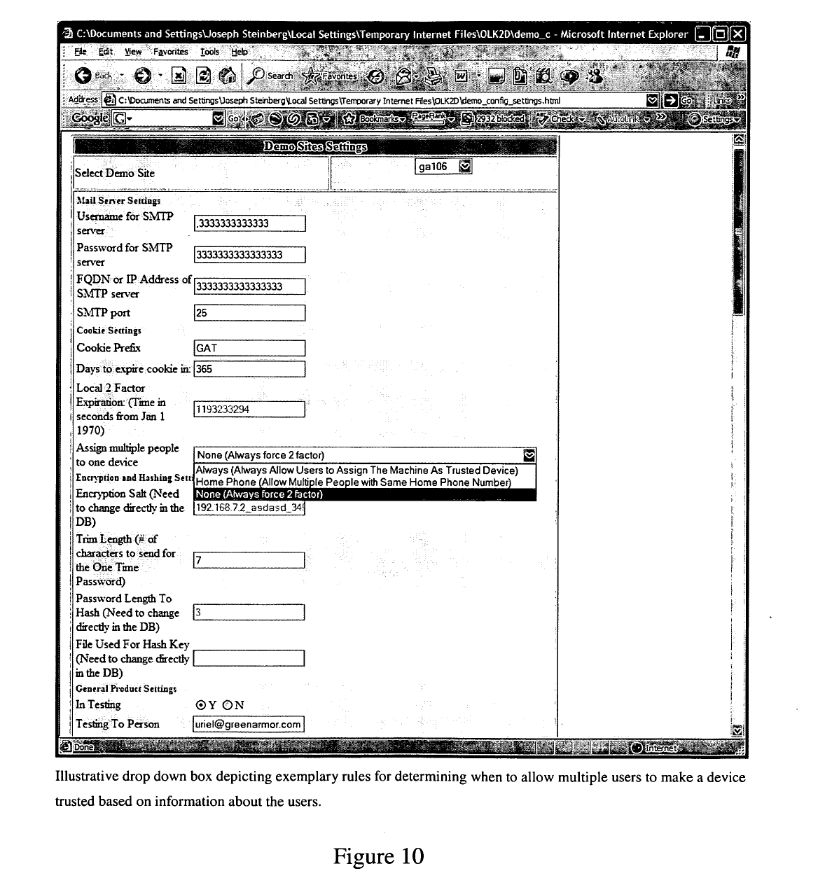

FIG. 9 depicts an exemplary drop down box of the configurations that might be employed in sending maps to determine login origination and heuristic analysis scoring. On the top one can see configurations related to sending maps via email to inform users from where there most recent login took place, from where the most recent access from an unidentified computer took place, from where they currently are logging in, etc. On the bottom one can see a simple interface for configuring heuristic analysis scoring. FIG. 10 depicts an exemplary drop down box of the rules that might be employed in establishing trusted device determinations.

Thus, with attention to the overall illustrative steps in providing the present invention, FIGS. 11A-C depict an exemplary flow of an illustrative implementation of the invention. As seen in FIG. 11A, a user comes to a site at step 1110 and a sample flow of an exemplary implementation of the invention is depicted for when a user logs in for the first time from his own computer whereupon a given system employing the present invention knows that the given computer of the purported user is not to be trusted as being associated with this particular user at step 1112. Thereafter, at step 1114 the user enters usemame and requests that system use two-factor authentication to authenticate him—in this example—he asks for a one-time password to be sent to the cell phone in his possession previously identified to the owner of the system. At step 1116 a one-time password is sent to the cell phone via SMS or email. Thereafter, the user enters one time password and his password on the screen 1118, and an (optional) visual cue is generated at step 1120. Subsequent to that, at step 1122 the user clicks submit and logs in. Either now at step 1124, or optionally at any point during his session, user may click a link that allows him to make his computer “trusted” for subsequent login attempts. Thereafter, the inventive system sends some identifier to the computer (as a cookie, certificate, etc.), and/or records identifying information about that machine (e.g., network number from IP address, checksum of various items in the hardware or software, IP address, etc.) at step 1126, and thereafter, user continues his session 1128. After the first login, if the dual factor method is invisible, it may entail behind the scenes checking of the information related to this machine and user combination being trusted—i.e., checking that the user is accessing from the trusted device (something that the user has in his possession or is otherwise associated with this user). The user uses his standard username and password and the second factor is that the fact that he possesses the trusted computer—i.e., he is logging in from a device that he is known to possess. The device should be set to be trusted for this particular user, although it could be set to be trusted in general if desired. In actuality the device is not really trusted per se, but as used herein trusted shall merely mean that if the user who is trusted from this device logs in, he will be able to do so with a username and password, rather than with some overt two-factor system.

FIG. 11B illustrates an exemplary user logging in for the first time from a computer other than his own. Starting with step 1140, a user comes to the given site employing the inventive technology, wherein the system detects that the computer is not (as of yet) known to be “trusted” 1142. At step 1144 user enters username and requests that system use two-factor authentication to authenticate him—in this example—he asks for a one-time password to be sent to say, the cell phone in his possession, as previously identified to the owner of the system, upon which a one time password is sent to the cell phone via SMS or email at step 1146. Thereafter, user enters one time password and his password on the screen at step 1148. Subsequent to that, an optional visual cue is generated at 1150. At step 1152, user clicks submit and logs in.

In FIG. 11C is a depiction of an exemplary logging in by the given user after the first time that his computer has been established as “trusted”. As seen, at 1160, user comes to the site, whereupon the inventive system detects that his computer is known to be trusted by virtue of retrieving the identifying certificate, cookie, etc., although in different embodiments utilizing a database, this step may optionally occur later. At 1164, an optional step provides for the inventive system to display a visual cue for the user on this trusted machine. Thereafter, the user enters username and password at 1166, and an optional visual cue may be generated as the user types at 1168. Subsequent to that, the inventive system detects if the user who is trusted is the user who actually entered username at 1170. If the system determines that the (provisionally) trusted user is the same user who actually entered the username (e.g., determined by comparing the types username with the known list of usernames of users trusted from this device), then the user clicks submit and logs in at 1172. If the system determines that the (provisionally) trusted user is not the same user who actually entered the username (e.g., determined by comparing the types username with the known list of usernames of users trusted from this device), then the system goes back to the screen asking for the one time password and continues at Label X in FIG. 11A.

Hence, as part of the invention, if mutual (i.e., site) authentication using visual, audible, or otherwise recognizable cues (or combination of cues) is desired, whether or not two-factor authentication is used, the cues could be presented as users login, or in the case of a trusted device (e.g., computer, machine, cell phone as alternatively illustrated herein), possibly even before the user has entered anything into the login page. While it is possible that if the cues are conveyed to the user (played, displayed, etc.) before the user has typed anything, other parties using the trusted device would see/her/sense another user's cue, if these parties have physical access to the device they could do far worse things such as install key loggers, sound recorders, etc. and as such, this issue becomes moot. Others skilled in the art may disagree (as there are instances where a trusted machine may be lent to a semi-trusted party for a short period of time, an employee working in someone's home may inappropriately access his or her boss's computer, etc.), and therefore in an alternative embodiment, the present invention provides for the option of playing/displaying the cue as they user types his information. Nevertheless, given that a given system could determine that the device is trusted for a particular user (or set of users) before any information is typed, it could play or display the cues as part of the basic login page. If an implementation allowed for multiple users to be trusted from a computer then the default user cue would be conveyed to the user (displayed, played, etc.), no cue would be displayed, a pick list of users could be displayed, etc. If a visual, audible, or otherwise recognizable cue is generated before the user enters any information, then it could be generated through the application of a function on the device identification information stored on the device for authentication purposes (e.g., cookies, certificates, etc.), and could be accomplished by applying some function to the given device information or to the information stored on a device (e.g., cookie, cert, etc.) that is not used for authentication purposes, and could include in the calculation the certificate used by the web site, or could simply use a database lookup of cues corresponding to users or devices, or alternatively, could employ a combination of these techniques. However, as it will be readily apparent to those skilled in the art, many other methods can also be used and as such, the aforementioned are only examples of a few possible implementations. Thus, the result is that login pages can appear differently to trusted users, trusted users on trusted machines, to all users on trusted machines, or to untrusted users on untrusted machines (or a combination thereof). As one example, in FIG. 11-C at 1160 a user comes to a site and the system detects that the machine is trusted (1162) so it displays the cue to the user even before the user starts typing anything (1164).

In addition, it should be noted that the present invention may include, in other alternative embodiments, the use of transaction analysis, log analysis, and other techniques in conjunction with the two-factor and two-way (mutual) authentication described above. Provision of such would be useful in providing an even more robust continuum of protection than using just the unique combination of mutual authentication and transaction analysis. Furthermore, as a means of either augmenting the aforementioned authentication process or as an authentication method on its own the system can check that a device that the user is known to possess is in a similar location to the device being used for access—for example, that the user's cell phone or Blackberry® is in the same general area or specific area as the computer he is using for access (or he is even using the phone or BlackBerry).

As those skilled in the art will further appreciate, one of the serious deficiencies of prior authentication approaches is that authentication systems are often insecure when used across the Internet or any other insecure network due to the risk of man-in-the-middle attacks and similar attacks. Because the consequences of a criminal intercepting a user's credentials (fingerprints, passwords, personal information, etc.) can be disastrous for the user, the present invention specifically provides for two novel techniques to for use against such attacks. Either of these novel defenses may be employed as discreet defenses on each on its own, or in tandem with each other. Specifically, these techniques may comprise the following: (1) sending a warning message (via email, instant messenger, SMS, or thorough another channel of communication) that may be visible, audible, or otherwise sensed and may be in the form of either in a one-time-password message, through some signal on a user's screen, speakers, via telephone or other device, or separately to a user when access is attempted from an unrecognized device (or a device recognized, but not recognized as belonging to the particular user whose credentials were used), such that the invention would include sending this message in situations in which the correct username of a user was sent, but not the correct password, or in situations in which the correct username and password for a user are submitted, or in other scenarios where a “risky” situation may have occurred; or (2) presentation of a visual, audible, or otherwise easily recognizable cue to users and the presentation is only performed when users login in from either a machine with a trusted user or a device from which they themselves are trusted. Both of these novel mechanisms can protect users against man-in-the-middle attacks by warning them either through an explicit warning, or through the lack of a highly-recognizable element, that something is wrong. One example of this can be seen in FIG. 12-D, although there are numerous variants of implementations of the invention—this example is offered for purposes of illustrating just one implementation. Hence, at step 1190 supposing that the user responds to a phishing email and thereafter goes to a man-in-the-middle phishing site, at stage 1192 the man-in-the-middle loads from the real site and displays it to the user. The inventive system and method would therefore detect that the man-in-the-middle is not a machine trusted as this user (1194). The user then types in his username, expecting to see a cue (step 1196), however, when the man-in-the-middle relays the username to the system (1198), the real system employing the inventive techniques would not send the man-in-the-middle the cue for the username (1200), but would instead only send the one time password (and warning) in say, an email to the user (1200).

While a user can have multiple devices and therefore should be allowed to assign multiple computer or other devices to be recognized as belonging to him, there is also the issue of allowing multiple users to assign the same devices to be trusted for each of them. Part of the invention is the concept to implement the concept of allowing multiple users to be trusted from multiple devices, both with and without conditions. For example, the system can be configured to allow any multiple users to be trusted (e.g., identified) from a particular device, or only to allow multiple users if they share a home address or home phone number. This allows greater security if properly implemented, and helps to protect against users accidentally making other people's computers trusted in situations in which they should not assign such trust. As an example, a husband and wife would be allowed to assign the same computer as trusted for access to their separate accounts so that only a username and password would be needed and the device would be identified behind the scenes, but a stranger could not assign the same device as trusted. (The husband and wife could be expressly identified as such in data record, or the system could compare home addresses, home phone numbers, or other information to draw the conclusion that such a relationship or a similar one exists.) Another example might be allowing people who share the same work address to use be trusted from the same device, but not people who work from other places. The invention also includes more sophisticated logic—such as in situation in which users have multiple email addresses on file with a system (e.g., a work email address and a personal email address) and the system allows two users to make a machine trusted for themselves only if they used one time passwords to their work email addresses and share a work physical address, or if they both used a home email to receive a one time password and they share a common home phone number or address. The invention also includes the logic to choose the correct email address based on the geolocation information and IP address of the system being used for access (a user coming from his home town has his email sent to his home address, from his work town to his work address, etc.).

Accordingly, the present invention offers a novel form of security that can prevent fraud and other problems based on information about the usual users of a device and usage pattern. For example, it might be beneficial to employ the novel invention so as to instantiate rules that might say: allow users to change passwords online only if they are accessing a system from a device from which they are known to have logged in for more than, say, 30 days; or allow financial transactions over a certain dollar figure to occur only from devices known to belong to the user issuing the transaction for some period of time. Furthermore, additional security can be overlaid in situations that are deemed sensitive and risky—for example while a user from a trusted device may be logging in to an online system using the invented system with just a username and password, the detection of the user's specific computer is behind the scenes and invisible to the user. As such, if the user requests performance of some specific activities (e.g., a large online payment to a new payee) the user will be required to authenticate also using the other method of two-factor authentication (e.g., the one-time password). For example, in FIG. 11-E, if a user wants to change his password and then clicks a change password button (1300), the inventive system will check if the user is accessing the system from a device known to belong to the user for at least X days (1310); if the user is trusted from the device for a period of X days it will allow the user to proceed (1320), and if not, it will not allow the user to proceed or access the system or site (1330). Accordingly, the setting of business security policies and some pre-set rules may be based on information about how “trusted” a device is for a particular user or users in general (based on binding it to specific users) is therefore an important improvement within the scope of the current invention.

With attention now to the identity of users and the use of heuristic analysis, additional details about the two methods of identifying a user's device are detailed below. Although the formulas for heuristic analysis have numerous variables to address several situations, a few of the possible scenarios are illustrated below as follows:
a) User is coming from a device with no identifier and the profile of the machine as gathered during the start of the session does not match a profile known for this user;
b) The user is coming from a device with an identifier that does not match this user and the profile of the machine as gathered during the start of the session does not match a profile known for this user;
c) The user is coming from a device with an identifier that matches this user and the profile of the machine as gathered during the start of the session does not match a profile known for this user;
d) The user is coming from a device with an identifier that does not match this user and the profile of the machine as gathered during the start of the session does not match a profile known for this user;
e) The user is coming from a device with no identifier but the profile of the machine as gathered during the start of the session matches a profile known for this user;
f) The user is coming from a device with an identifier that matches this user and the profile of the machine as gathered during the start of the session does match a profile known for this user.

In addressing the above and other scenarios, the novel heuristic techniques of the present invention may be employed. Specifically, the heuristic techniques of the present invention may involve establishing profiles that are based upon known user specifics, according to various pre-set rules and will establish identity thereon. Heuristic profiles may be based on one time access or may be refined and developed over time by profiling during numerous user access attempts and logins. This is especially pertinent when identifiers are involved. For example, if the system sees user “John” login from a machine (e.g., computer) to which it has added identifier X (e.g., a cookie) and sees the IP address and ISP of that machine change, but everything else stay the same over and over, it may be able to discern that the machine is a laptop, whereas if the IP address stays the same and there is a proxy from a large corporation detected—it is likely a desktop in a big company. These pieces of information can be included within heuristic analysis as individual data elements and/or as a pattern. Furthermore, if a browser is detected as having been upgraded it may be a sign of a problem if we later detect it that it appears to have been downgraded. Also, composite heuristics can be used. It may be acceptable for geolocation on a notebook to show it in New York on Day 1 and in Beijing a week later, but not in New York and in Beijing an hour later. An example of basic heuristic analysis is depicted in FIG. 11-F, wherein a user is logging in from a trusted device (1400) and the system recognizes it as so based on an identifier (1410), the system then runs the heuristic analysis (1420), and compares the results to known properties of the device (1430). If there is a match (based on an acceptable pre-set minimum), then the user is allowed access to a site or system (1440), and if not, other corrective action may be taken (1450). Note that there can be multiple levels of acceptance as well, such that, as referenced in step 1450, different corrective actions may be taken based upon different levels of a match.

In providing the heuristic analysis, it may be further useful to establish a value (or weight) of each variable. These values may be individual, composite, or complicated parts of the analysis and can vary between implementations based on business needs. Furthermore, the total passing and failing score for considering a device to be a match may be dynamic and based upon different pre-set rules based on different scenarios and different organizations. For example, a score may be considered a match if the identifier is present and the system is double-checking that the identifier was not stolen, something which may be different than the score needed to consider two devices a “match” (eg identified) in cases where no identifier is present. Furthermore, composite and complicated analysis such as those mentioned in the previous paragraph necessitate as part of the invention the concept offers robust scoring mechanisms and contingent rules (e.g., if the time zone has changed, then if it is more than X hours since the previous time zone was detected than do X otherwise do y).

Depending on the heuristic score, and whether a non-match is established, resulting actions to be taken include: allowing access, blocking access, requiring an overt dual-factor authentication even from an identified device (with an identifier) if a problem is detected heuristically, locking the account, allowing access but triggering an alert to an administrator to monitor for fraud, and other responses. Also, access may be granted if an identifier is missing but the heuristics detect the device to look similar or exactly the same as one trusted for the particular user who correctly submitted his or her username and password.

As those skilled in the art will appreciate, it is possible to create a federated system of the aforementioned inventions in the present invention. For example, if a user has a visual cue that is generated through selecting a visual cue or is calculated by applying a function to some input but that body allows cues to be displayed on the sites of other legitimate websites (or sent in their email messages, etc.), then the system may display cues to users even before they become customers of the entity displaying the cue. This can help address the problem of phony sites and phishing when it comes to the opening of new accounts. A cue could be any human-friendly representation, an might be done online, via phone, or at an Automated Teller Machine (ATM), etc. Such a cue could be accomplished through of the use of a logo that cannot be spoofed. Provision of such is deemed a significant improvement over current security seals (and even timestamps), such as those available from Geotrust®, Verisign®, etc. which can be spoofed easily. Furthermore, to address users who have an existing relationship with an entity, but not some specific online, phone, or other electronic access, the inventive site authentication capability could also be used in the non-electronic world (e.g., printed on a statement or on letters sent to users) the use of a site authentication cue in the non-electronic world is a further embodiment contemplated by the present invention. Provision of such prevents problems related to mail fraud and also encourages users to become accustomed to the cue, so that if they enroll in online/phone access, they will already recognize it. Several illustrative examples of this may be seen in FIGS. 11-G and 11-H. If an organization wants to send a physical letter to a user it can prepare the letter (1500), calculate the cue using the same method it calculates it when users login to the web site (151), and add the cue to the letter (1520). The same holds true in the example using the telephone—whether the user called the organization or the organization calling the user (1600), the cue can be presented (either based on the number dialed, caller ID, or the user may enter or speak his username 1610) and the cue is generated (as it would for the web site—either from a database, algorithmicly, or using a combination of both 1620), and the cue is presented audibly to the user (1630).

It is to be understood that the invention is not limited to the illustrations described and shown herein, which are deemed to be more illustrative of several of the anticipated best modes of carrying out the invention, and which are susceptible of modification of form, size, and arrangement of parts and details operation. These modifications are within the spirit and scope of the appended claims.

1. A method for improving authentication of interacting parties comprising the use of two or more forms of authentication at least one of which uses at least two methods of authenticating users, said form of authentication comprising:
a multi-factor authentication step for authenticating a user from a computer, said multi-factor authentication comprising steps chosen from the group of using one-time password verification, using certificates, using Public Key Infrastructure components, using hardware devices that can be attached to a system, using physical devices not physically attached to the system, or using biometrics.
assessing a trusted status of said computer, said user, and said system, based upon analyzing of a result of said step of multi-factor authentication.

2. The method of claim 1, further comprising the step of using site authentication between a user and a system being accessed and optionally further including a step of analyzing a result of said site authentication so as to further assess said trusted status of said computer, said user and said system.

3. The method of claim 2, further comprising the step of utilizing transaction/behavior analysis in performing said authentication.

4. The method of claim 3 wherein said mutual authentication includes the step of providing for said system being accessed to authenticate the user prior to the user having to submit a username or other login credentials.

5. The method of claim 4 further comprising the step of hiding at least some authentication factors from said user.

6. A method of providing the ability to address man-in-the-middle attacks through the presentation of at least one recognizable cue in order to establish authenticity of a computer only when a user is accessing from an identified computer.

7. The method of claim 6 further comprising the step of sending a warning message via email, SMS, or other out of band carrier to the user to warn of possible existence of said man-in-the-middle attacks.

8. The method of claim 4 further comprising the presentation of a recognizable audible, visual, or other cue indicating the trusted status of the computer of said user.

9. A method of providing communication out-of-band to a user indicating geolocation information in the form of text or a map that shows at least a general location where the user is accessing a system so that said user can detect any fraudulent access.

10. The method of claim 2, wherein said steps of providing site authentication further provide for the authentication of computers involved in online sites, email messages, instant messages, SMS messages, telephone calls, ATM machine, paper-based messages, and other communication systems.

11. The method of claim 10, further including steps to provide a colored box with colored or uncolored characters within said box to said user as a cue for said site authentication.

12. The method of claim 11, further including a step for portraying explanatory textual information along with said cue to said user so as to ensure that said system can authenticate within systems that can only process text.

13. The method of claim 12, further including the step of creating and applying business logic based on information garnered about devices of said user and a length of time during which said computer of said user is known to belong to a specific user and a login pattern of the user from said device.

14. The method of claim 13, further comprising the step of using both identifiers and heuristic analysis to determine the identity of a computer, user, or entity.

15. The method of claim 14, further comprising the ongoing modification of the assessment of said trusted status of a computer of said user based upon analysis of user actions from said computer of said user or from other computers utilized by said user.

16. The method of claim 15, further including the step of presenting a different login page for said user and said computer depending on whether each has been assessed as trusted or not trusted.

17. The method of claim 1 wherein said step of assessing a trusted status further comprising at least one of the following steps: allowing a trusted status for multiple identified users accessing from the same identified computer, disallowing a trusted status for multiple users accessing the same device trusted, or allowing a trusted status for multiple identified users accessing from multiple computers according to pre-set conditions.

18. A method of providing authentication to a mobile electronic device comprising the steps of:
producing a scannable barcode which can be displayed for scanning by another device, said scannable barcode being produced through calculations performed on processors within the mobile electronic device;
sending a signal to another electronic device for identification and authentication purposes, said signal being modified based on information sent to the mobile electronic through a cellular, network, or other data connection;
sending a signal to another electronic device for identification and authentication purposes, said signal being modified based on information contained within a processor inside the device
processing at least an ESN present in said mobile electronic device to authenticate a user:
sending said ESN in a secure encrypted or hashed fashion, to another electronic device as a key;
sending data encrypted or hashed using the ESN as a key to another electronic device.

19. A method of leveraging geolocation information made available by cell phones and handheld devices to a system being accessed in order to authenticate users, comprising the following steps:
checking the location of a given computer, phone, handheld or other device not being used to access a system while access is attempted from another computer, phone, handheld or other device
allowing access only if the location of said given computer, phone, handheld or other device being used to access a system are within a range of pre-set rules within the system;
allowing access only if the location of said computer, phone, handheld, or other device not being used for access are within an acceptable range of the device being used for access; and
allowing access only if the location of said computer, phone, handheld, or other device being used for access are within an acceptable range of the device being used for access.

20. A system for improving authentication of interacting parties comprising the use of two or more authentication modules, at least one of which comprises at least two sub-modules for authenticating users, said system comprising:
a multi-factor authentication module for authenticating a user from a computer, said multi-factor authentication comprising sub-modules chosen from the group of one-time password verification sub-modules, hardware-checking sub modules, certificate producing sub-modules, Public Key Infrastructure components, or biometric based authentication sub-modules.
an assessment module for assessing a trusted status of said computer, said user, and said system, based upon analyzing of a result of said step of multi-factor authentication.

21. The system of claim 20, further comprising a module for using site authentication between a user and a system being accessed to authenticate themselves to each other and optionally further including a module for analyzing a result of said site authentication so as to further assess said trusted status of said computer, said user and said system.

22. The system of claim 21, further comprising a module for utilizing transaction/behavior analysis in performing said authentication.

23. The system of claim 23 wherein said mutual authentication module includes a sub-module for providing said system being accessed to authenticate the user prior to the user having to submit a username or other login credentials.

24. The system of claim 23 further comprising a module for hiding at least some authentication factors from said user.

25. A system having a module for providing the ability to address man-in-the-middle attacks through the presentation of at least one recognizable cue in order to establish authenticity of a computer only when a user is accessing from an identified computer.

26. The system of claim 21 further comprising a module for sending a warning message via email, SMS, or other out of band carrier to the user to warn of possible existence of said man-in-the-middle attacks.

27. The system of claim 21, further comprising a module for presentating a recognizable audible, visual, or other cue indicating the trusted status of the computer of said user.

28. A system having a module for providing communication out-of-band to a user indicating geolocation information in the form of text or a map that shows at least a general location where the user is accessing a system so that said user can detect any fraudulent access.

29. The system of claim 20, wherein said module for providing site authentication further includes a sub-module providing for the authentication of computers involved in online sites, email messages, instant messages, SMS messages, telephone calls, ATM machine, paper-based messages, and other communication systems.

30. The system of claim 29, further including a sub-module for providing a colored box with colored or uncolored characters within said box to said user as a cue for said site authentication.

31. The system of claim 29, further including a sub-module for portraying explanatory textual information along with said cue to said user so as to ensure that said system can authenticate within systems that can only process text.

32. The system of claim 31, further including a sub-module for creating and applying business logic based on information garnered about devices of said user and a length of time during which said computer of said user is known to belong to a specific user and a login pattern of the user from said device.

33. The system of claim 32, further comprising a sub-module for using both identifiers and heuristic analysis to determine the identity of a computer, user, or entity.

34. The system of claim 33, further comprising a sub-module for providing ongoing modification of the assessment of said trusted status of a computer of said user based upon analysis of user actions from said computer of said user or from other computers utilized by said user.

35. The system of claim 34, further including a sub-module for presenting a different login page for said user and said computer depending on whether each has been assessed as trusted or not trusted.

36. The system of claim 20 wherein said module for assessing a trusted status further comprising at least one sub-module for: allowing a trusted status for multiple identified users accessing from the same identified computer, disallowing a trusted status for multiple users accessing the same device trusted, or allowing a trusted status for multiple identified users accessing from multiple computers according to pre-set conditions.

37. A system of providing authentication to a mobile electronic device comprising:
a module for producing a scannable barcode which can be displayed for scanning by another device, said scannable barcode being produced through calculations performed on processors within the mobile electronic device;
a module for sending a signal to another electronic device for identification and authentication purposes, said signal being modified based on information sent to the mobile electronic through a cellular, network, or other data connection;
a module for processing at least an ESN present in said mobile electronic device to authenticate a user:
a module for sending said ESN in a secure encrypted or hashed fashion to another electronic device as a key;
a module for sending a signal to another electronic device for identification and authentication purposes, with said signal being modified based on information contained within a chip inside the device; and
a module for sending data encrypted or hashed using the ESN as a key to another electronic device.

38. A system for leveraging geolocation information made available by cell phones and handheld devices to a system being accessed in order to authenticate users, comprising the following:
a module for checking the location of a given computer, phone, handheld or other device being used to access a system while access is attempted from another computer, phone, handheld or other device;
a module for allowing access only if the location of said given computer, phone, handheld or other device being used to access a system are within a range of pre-set rules within the system;
a module for allowing access only if the location of said computer, phone, handheld, or other device not being used for access are within an acceptable range of the device being used for access; and
a module for allowing access only if the location of said computer, phone, handheld, or other device being used for access are within an acceptable range of the device being used for access.
